(19) United States
(12) Patent Application Publication
(10) Pub. No.: US 2026/0051682 A1
(43) Pub. Date: Feb. 19, 2026

(54) CONNECTOR, CIRCUIT BOARD ASSEMBLY, AND ELECTRONIC DEVICE

(71) Applicant: HUAWEI TECHNOLOGIES CO., LTD., Shenzhen (CN)

(72) Inventors: Caizhang WU, Shenzhen (CN); Liang XIONG, Dongguan (CN); Jun YU, Dongguan (CN); Jun CHEN, Dongguan (CN)

(21) Appl. No.: 19/366,764

(22) Filed: Oct. 23, 2025

Related U.S. Application Data
(63) Continuation of application No. PCT/CN2023/136248, filed on Dec. 4, 2023.

(30) Foreign Application Priority Data
Apr. 24, 2023 (CN) 202310467041.0

(51) Int. Cl. H01R 12/91; H01R 12/70

(52) U.S. Cl. CPC H01R 12/91; H01R 12/7005

(57) ABSTRACT

A connector which includes a fixed housing, a connector plug, a first elastic member, and a stopper. The fixed housing includes a bottom wall and side walls, and the bottom wall and the side walls are connected to form an insertion cavity. The connector plug is mounted in the insertion cavity, and a first gap exists between the connector plug and the side wall. The first elastic member is disposed between the bottom wall and the stopper, and is configured to drive the stopper to float in a plug-connect direction of the connector plug, and a second gap exists between the stopper and the connector plug. The fixed housing is fastened to a first limiting block, and the first limiting block is disposed on a side that is of the stopper and that is away from the first elastic member.

### CROSS-REFERENCE TO RELATED APPLICATIONS

This application is a continuation of International Application No. PCT/CN2023/136248, filed on December 4, 2023, which claims priority to Chinese Patent Application No. 202310467041.0, filed on April 24, 2023. The disclosures of the aforementioned applications are hereby incorporated by reference in their entireties.

### TECHNICAL FIELD

This disclosure relates to the field of electronic device technologies, and in particular, to a connector, a circuit board assembly, and an electronic device.

### BACKGROUND

With ongoing advancement of modern electronic devices, the quantity of transmitted signals continues to grow, and their rates become increasingly faster. As a result, the quantity of electronic components disposed in the electronic device also increases, and the integration level is increasingly high. In this way, the size of a circuit board assembly gradually increases, and the weight gradually increases. Signal transmission between different circuit board assemblies needs to be implemented by using connectors. On a large-sized and heavy chassis, the connectors are subject to larger torsional force and larger lateral force. However, the foregoing torsional force and lateral force easily cause a partial mating distance (demating value) between the connectors to be relatively large, and it is difficult to increase a signal transmission rate of the connectors. However, in an evolution process of an electronic device, it is a very important objective to improve a signal transmission rate. Therefore, effect of mutual matching between connectors needs to be improved, and a partial mating distance between the connectors needs to be reduced.

### SUMMARY

This disclosure provides a connector, a circuit board assembly, and an electronic device. Demating values of the connector and a counterpart connector in various directions are relatively small, to improve effect of connection between a connector plug and the counterpart connector, thereby improving signal transmission efficiency of the electronic device.

According to a first aspect, this disclosure provides a connector. The connector may be specifically a plug-in connector, and is connected to a counterpart connector in a plug-connect manner. The connector includes a fixed housing, a connector plug, a first elastic member, and a stopper. The fixed housing includes a bottom wall and side walls, and the bottom wall and the side walls are connected to form an insertion cavity, and a tubular insertion cavity may be specifically formed. The connector plug is floatingly mounted in the insertion cavity, and a first gap exists between the connector plug and the side wall, so that the connector plug has a mobile margin between the side walls, so that the connector plug can float in a first plane, thereby aligning the connector plug with the counterpart connector for plug-connection. The first plane may be specifically a plane perpendicular to the plug-connect direction. The first elastic member is disposed between the bottom wall and the stopper, and the first elastic member is configured to drive the stopper to float in the plug-connect direction of the connector plug. The stopper is located between the connector plug and the first elastic member, and a second gap exists between the stopper and the connector plug in the plug-connect direction. As the connector plug and the counterpart connector are plug-connected in the plug-connect direction, the connector plug moves toward the stopper. When a moving distance is greater than the second gap, the connector plug presses against the stopper. When plug-connect force is greater than preload of the first elastic member, the connector plug drives the stopper to move toward the bottom wall, so that the connector floats in the plug-connect direction. The fixed housing is fastened to a first limiting block, and the first limiting block is disposed on a side that is of the stopper and that is away from the first elastic member. In some technical solutions, the first limiting block is located between the stopper and the connector plug, and limits the stopper, to ensure that a second gap exists between the stopper and the connector plug in a natural state (a state in which the connector is not plug-connected to the counterpart connector). In addition, the first elastic member may be further enabled to remain preloaded, to drive the stopper to press against the first limiting block, so that the first elastic member can provide particular preload. In this case, when the connector is plug-connected to the counterpart connector, the first elastic member drives the connector plug to press against counterpart connector. A demating value of the connector plug and the counterpart connector in the plug-connect direction is relatively small, to improve effect of connection between the connector plug and the counterpart connector.

To improve effect of alignment between the connector and the counterpart connector, a guide assembly is disposed between the connector and the counterpart connector. The guide assembly includes a guide sleeve and a guide pin, and the guide pin may be inserted into the guide sleeve to perform coarse positioning. Specifically, in a possible embodiment, the fixed housing is provided with a first guide sleeve, the counterpart connector is provided with a first guide pin, and when the connector and the counterpart connector are in an engagement state, the first guide pin is inserted into the first guide sleeve. In a process in which the connector is plug-connected to the counterpart connector, the first guide pin is first inserted into the first guide sleeve, and then plug-connection is continued, so that the connector plug is plug-connected to the counterpart connector.

Similarly, in another possible embodiment, the fixed housing may alternatively be provided with a second guide pin, the counterpart connector is provided with a second guide sleeve, and when the connector and the counterpart connector are in an engagement state, the second guide pin is inserted into the second guide sleeve. As compared with the foregoing embodiment, a difference lies only in that the guide pin and the guide sleeve are disposed at opposite positions.

The connector may further include a second elastic member, and the second elastic member is disposed in a first gap between the connector plug and the side wall. The second elastic member is configured to drive the connector plug to float in the first plane. When the connector is in a natural state, the second elastic member drives the connector plug to remain at a preset initial position, for example, in the middle, to align and connect to the counterpart connector. In addition, when the connector and the counterpart connector are in the engagement state, the second elastic member is further configured to drive the connector plug to press against the counterpart connector in the first plane, and a demating value of the connector plug and the counterpart connector in the first plane is relatively small, to improve effect of connection between the connector plug and the counterpart connector.

When the second elastic member is specifically disposed, the connector may include two groups of second elastic members, and the two groups of second elastic members are disposed on two sides that are away from each other of the connector plug. In this technical solution, the two groups of second elastic members apply force to the connector plug in two opposite directions. This helps keep the connector plug at a preset position.

In addition, in a further technical solution, the connector may alternatively include four groups of second elastic members, and the four groups of second elastic members are disposed around the connector plug. In this solution, force may be applied to the connector plug from around the connector plug, to help keep the connector plug at the preset position.

When the second gap is specifically provided, the second gap may be less than or equal to 1 millimeter. In this case, the second gap enables the connector plug not to be in contact with the stopper when the connector is in a natural state, so that relatively good floating effect is achieved in the first plane. However, in a process in which the connector is plug-connected to the counterpart connector, provided that movement in the plug-connect direction does not exceed 1 mm, the connector plug can be in contact with and press against the stopper. This helps implement floating of the connector in the plug-connect direction and improve tightness of the connector and the counterpart connector in the plug-connect direction.

The fixed housing is fastened to a second limiting block, and the second limiting block is located on a side that is of the first limiting block and that is away from the bottom wall. The connector plug includes a shoulder stop, the shoulder stop is located between the second limiting block and the stopper, and the shoulder stop is in lap joint with the second limiting block. The second limiting block is disposed, so that the connector plug is limited on a side that is of the second limiting block and that faces the bottom wall, and does not fall off from the fixed housing.

Two ends of the connector plug are respectively limited by the stopper and the second limiting block, and the second gap between the connector plug and the stopper is relatively small. Therefore, an included angle between a surface that is of the connector plug and that faces the stopper and a surface that is of the stopper and that faces the connector plug is less than or equal to 2 degrees. Further, the included angle between the surface that is of the connector plug and that faces the stopper and the surface that is of the stopper and that faces the connector plug may be less than or equal to 1 degree. In this solution, a rotation angle of the connector plug in the fixed housing can be reduced.

When the stopper is specifically disposed, a clearance fit exists between the stopper and the side wall. In this case, when the stopper slides relative to the fixed housing, relatively small friction force is generated. This helps improve smoothness of a sliding process of the stopper.

To further improve smoothness of the sliding process of the stopper, a lubricant may be disposed between the stopper and the side wall.

In a specific embodiment, a specific type of the foregoing connector plug is not limited. In a possible embodiment, the connector plug is a female connector; or in another possible embodiment, the connector plug may be a male connector.

According to a second aspect, this disclosure further provides a circuit board assembly. The circuit board assembly includes a circuit board, an electronic component, and any connector disclosed in the first aspect. The electronic component is disposed on the circuit board, and the electronic component is electrically connected to the connector plug of the connector. The connector of the circuit board assembly may float in three directions. This helps reduce a demating value of plug-connection between the connector and a counterpart connector, improve effect of connection between the connector plug of the connector and the counterpart connector, and improve a rate of signal transmission between circuit board assemblies.

In a specific technical solution, the circuit board assembly further includes an electrical connection line. The electrical connection line is connected between the electronic component and the connector plug. In this solution, the electrical connection line may move with floating of the connector plug, so that the connector plug floats freely.

According to a third aspect, this disclosure further provides an electronic device. The electronic device includes a housing and the circuit board assembly in the second aspect, where the circuit board assembly is disposed in the housing. Effect of connection between the connector in the electronic device and a counterpart connector is relatively good. This helps improve a signal transmission rate of the electronic device.

In a specific technical solution, the fixed housing and the circuit board are fixedly mounted in the housing separately; and the circuit board assembly further includes the electrical connection line, where the electrical connection line is connected between the electronic component and the connector plug. In this solution, the connector may not be directly fastened to the circuit board, and disposition flexibility is relatively high.

In another specific technical solution, the fixed housing may alternatively be fastened to the circuit board. This is specifically designed based on an actual requirement. This is not specifically limited in this disclosure.

### BRIEF DESCRIPTION OF DRAWINGS

FIG. 1 is a diagram of a structure of an electronic device according to an embodiment of this disclosure;

FIG. 2 is a diagram of a structure of another electronic device according to an embodiment of this disclosure;

FIG. 3 is a diagram of a structure of a connector and a counterpart connector according to an embodiment of this disclosure;

FIG. 4 is a diagram of a structure of a circuit board assembly according to an embodiment of this disclosure;

FIG. 5 is a diagram of a cross-sectional structure of a connector according to an embodiment of this disclosure;

FIG. 6 is a diagram of a structure of a connector and a counterpart connector according to an embodiment of this disclosure;

FIG. 7 is a diagram of a structure of another connector and a counterpart connector according to an embodiment of this disclosure;

FIG. 8 is a diagram of a structure of another connector and a counterpart connector according to an embodiment of this disclosure; and

FIG. 9 is a diagram of a cross-sectional structure of a connector according to an embodiment of this disclosure.

### Reference numerals:

1: housing; 2: circuit board assembly;

3: circuit board; 4: electronic component;

5: connector; 6: backplane;

7: counterpart connector; 8: electrical connection line;

01: fixed housing;

011: bottom wall; 012: side wall;

013: insertion cavity; 014: opening;

02: connector plug; 021: shoulder stop;

03: first elastic member; 04: stopper;

05: first limiting block; 06: second limiting block;

07: guide sleeve; 08: guide pin;

09: second elastic member; a: first gap;

b: second gap.

### DESCRIPTION OF EMBODIMENTS

To make the objectives, technical solutions, and advantages of this disclosure clearer, the following further describes this disclosure in detail with reference to the accompanying drawings.

Terms used in the following embodiments are merely intended to describe specific embodiments, but are not intended to limit this disclosure. The terms "one", "a", "the" and "this" of singular forms used in this specification and the appended claims of this disclosure are also intended to include expressions such as "one or more", unless otherwise specified in the context clearly.

Reference to "an embodiment", "specific embodiments", or the like described in this specification indicates that one or more embodiments of this disclosure include a specific feature, structure, or characteristic described with reference to the embodiments. The terms "include", "have", and their variants all mean "include but are not limited to", unless otherwise specifically emphasized in another manner.

For ease of understanding a connector, a circuit board assembly, and an electronic device provided in embodiments of this disclosure, the following first describes an disclosure scenario of the connector, the circuit board assembly, and the electronic device.

The electronic device in embodiments of this disclosure may be an electronic device such as a communication device (for example, a router), a computing device (for example, a server), a network device (for example, a switch), or a storage device (for example, a storage array), especially an electronic device with a high-power consumption component. A specific type of the electronic device is not limited in this disclosure, and the technical solutions provided in this disclosure may be used for any electronic device that needs to be connected by using a connector.

For ease of understanding the technical solutions of this disclosure, a technical term is explained as follows: A partial mating distance (demating value) is a gap between two connectors after a male connector and a female connector match each other. In an ideal state, if the two connectors are completely plug-connected, the demating value is zero. It may be considered that a smaller demating value indicates a state of tighter connection between the two connectors.

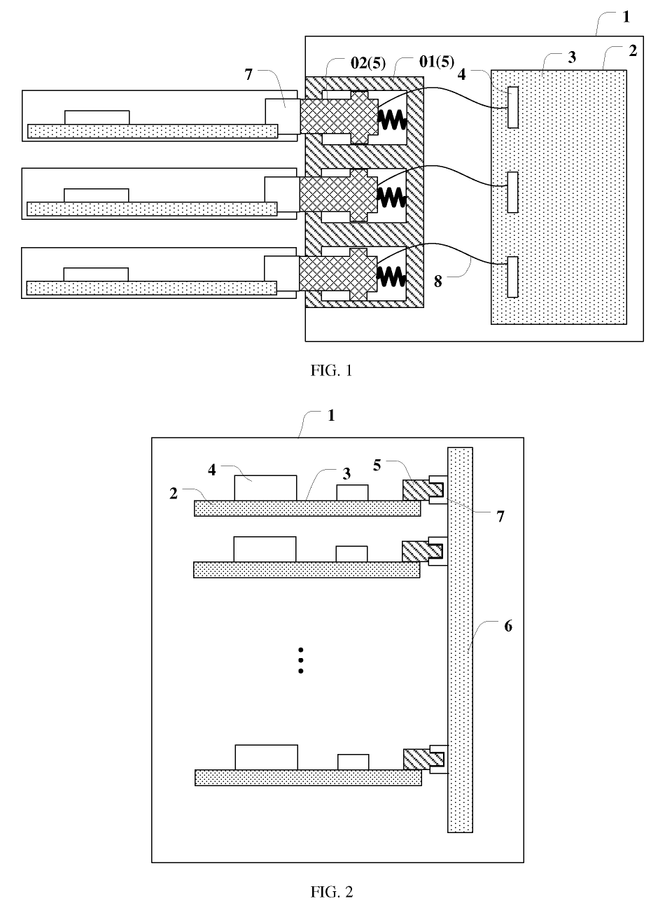

For ease of description, in embodiments of this disclosure, an example in which the electronic device is a server is used for description. FIG. 1 is a diagram of a structure of an electronic device according to an embodiment of this disclosure. As shown in FIG. 1, the electronic device may include a housing 1 and a circuit board assembly 2 disposed in the housing 1. Specifically, when the electronic device is a cabinet-class server, the housing 1 may be understood as a cabinet body of the cabinet-class server, and the circuit board assembly 2 may include nodes. As shown in FIG. 1, the circuit board assembly 2 specifically includes a circuit board 3 and a plurality of electronic components 4, and the plurality of electronic components 4 are disposed on the circuit board 3 to form the circuit board assembly 2. As functions of the electronic device become increasingly rich, a growing quantity of electronic components 4 are disposed on the circuit board 3 of the circuit board assembly 2, and power of the electronic components 4 also increases. For example, an artificial intelligence (AI) chip or a graphics processing unit (GPU) may be disposed on the circuit board 3, and is configured to perform computing-bound or memory-bound service data processing such as artificial intelligence or high performance computing (HPC).

To implement signal and power supply transmission between different circuit board assemblies 2, different circuit board assemblies 2 are connected by using connectors, to implement signal transmission or power supply. In other words, the circuit board assembly 2 further includes a connector 5, and the connector 5 and the electronic component 4 are electrically connected by using the circuit board 3, to transmit a signal or supply power. Specifically, the connector 5 generally includes a male connector and a female connector. The male connector is plug-connected to the female connector, to implement signal transmission. In the embodiment shown in FIG. 1, in an embodiment, with development of high-density of an electronic device, different nodes in the electronic device may be disposed orthogonally. Specifically, the electronic device includes nodes disposed horizontally and nodes disposed vertically. Different nodes are connected by using the connector 5 and a counterpart connector 7. The connector 5 includes a fixed housing 01 and a connector plug 02, and the connector plug 02 is floatingly mounted in the fixed housing 01. The fixed housing 01 of the connector 5 and the circuit board 3 are fixedly mounted in a housing 1 separately, and the circuit board assembly 2 further includes an electrical connection line 8. The electrical connection line 8 is connected between the connector plug 02 and the electronic component 4, so that the connector plug 02 is electrically connected to the electronic component 4. Specifically, the electrical connection line 8 may be directly electrically connected to the electronic component 4, or the electrical connection line 8 may be electrically connected to the circuit board 3, and the electronic component 4 is electrically connected to the circuit board 3, so that the electrical connection line 8 is electrically connected to the electronic component 4 by using the circuit board 3. In this embodiment, the connector plug 02 is electrically connected to the electronic component 4 by using the electrical connection line 8, and the electrical connection line 8 is flexible to some extent. Therefore, when the connector plug 02 moves in the fixed housing 01, reliability of connection between the connector plug 02 and the electronic component 4 is slightly affected. This helps improve a service life of the circuit board assembly 2.

FIG. 2 is a diagram of a structure of another electronic device according to an embodiment of this disclosure. As shown in FIG. 2, in another embodiment, the electronic device further includes a backplane 6. Different nodes are separately connected to the backplane 6 by using connectors 5. In this case, signal transmission may be implemented between different nodes by using the backplane 6. For ease of description, description is provided from the perspective of the node. The node includes the connector 5. A fixed housing of the connector is fixedly mounted on a circuit board of a circuit board assembly, the backplane 6 includes a counterpart connector 7, and the connector 5 is plug-connected to the counterpart connector 7, so that the node can be connected to the backplane 6. Certainly, the backplane 6 may also be understood as the circuit board assembly 2. In another embodiment, the backplane 6 including the connector 5 may be used as the circuit board assembly 2 provided in this disclosure, and the node includes the counterpart connector 7. Details are not described herein.

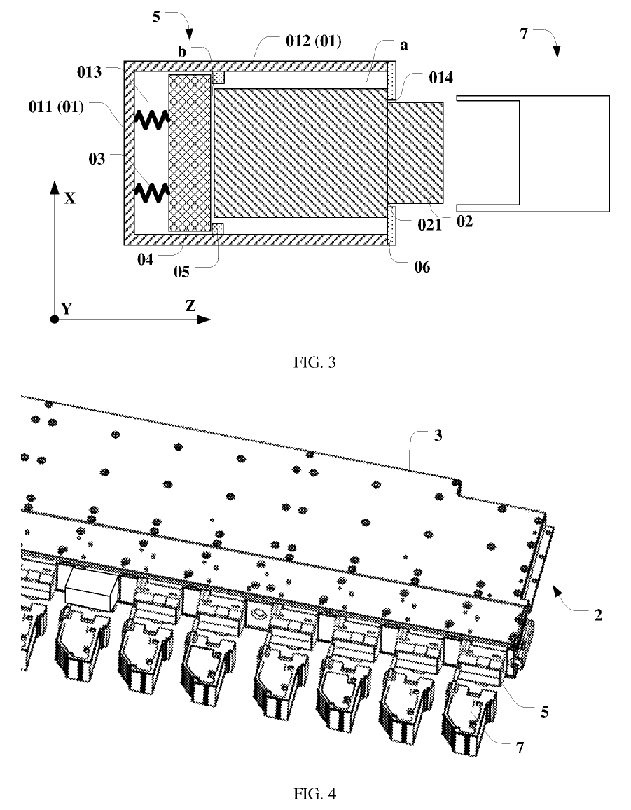

FIG. 3 is a diagram of a structure of a connector and a counterpart connector according to an embodiment of this disclosure. As shown in FIG. 3, in an embodiment, the connector 5 includes a fixed housing 01, a connector plug 02, a first elastic member 03, and a stopper 04. The fixed housing 01 includes a bottom wall 011 and side walls 012, and the bottom wall 011 and the side walls 012 are connected to form an insertion cavity 013. The connector 5 is a plug-in connector, that is, the connector 5 is connected to a counterpart connector 7 in a plug-connect manner. Specifically, the connector 5 is plug-connected to the counterpart connector 7 in a plug-connect direction Z. In a specific embodiment, it may be considered that the side wall 012 is parallel to the plug-connect direction Z, and the bottom wall 011 is perpendicular to the plug-connect direction Z. Specifically, the bottom wall 011 and the side walls 012 may form a sleeve shape, and the insertion cavity 013 is an inner cavity of the sleeve. Two ends of an extension direction of the sleeve are respectively the bottom wall 011 and an opening 014, and the side walls 012 are located on a periphery of the sleeve. Specifically, the side wall 012 and the bottom wall 011 may be of a plate-like structure, a hollow-out structure, or the like. This is not limited in this disclosure.

In a specific embodiment, when the connector 5 is mounted to a circuit board 3, the fixed housing 01 is fastened to the circuit board 3, and an electronic component 4 of a circuit board assembly 2 is specifically electrically connected to a connector plug 02 of the connector 5.

The connector plug 02 is mounted in the insertion cavity 013 formed by the bottom wall 011 and the side walls 012, and the connector plug 02 is plug-connected to the counterpart connector 7 by using the foregoing opening 014. A first gap a exists between the connector plug 02 and the side wall 012. The first gap a is disposed, so that the connector plug 02 has a mobile margin between the side walls 012, so that the connector plug 02 can float in a first plane. The first plane may be specifically a plane perpendicular to the plug-connect direction Z. Using a three-dimensional coordinate system as an example, the three-dimensional coordinate system includes an X direction, a Y direction, and a Z direction, where the Z direction is the plug-connect direction Z, and a plane determined by the X direction and the Y direction is the first plane. The connector plug 02 floats in the first plane, so that the connector plug 02 floats based on a position of the counterpart connector 7, so that the connector plug 02 is aligned with the counterpart connector 7 for plug-connection.

When the first elastic member 03 is specifically disposed, the first elastic member 03 is disposed between the bottom wall 011 and the stopper 04, and the first elastic member 03 is configured to drive the stopper 04 to float in the plug-connect direction Z of the connector plug 02. The fixed housing 01 is fastened to a first limiting block 05. The first limiting block 05 is disposed on a side that is of the stopper 04 and that is away from the first elastic member 03, and enables the first elastic member 03 to remain preloaded between the bottom wall 011 and the stopper 04, so that the stopper 04 can be driven to press against the first limiting block 05. In this solution, the first elastic member 03 remains preloaded, and provides elastic force (in the plug-connect direction Z of the connector 5) toward the first limiting block 05 for the stopper 04. The elastic force enables the stopper 04 to press against the first limiting block 05. In other words, the first limiting block 05 is disposed, and the stopper 04 is limited by the first limiting block 05, so that a distance between the stopper 04 and the bottom wall 011 is relatively short, and when the connector 5 is in a natural state (a disconnected state), the first elastic member 03 remains preloaded at a relatively short distance. The stopper 04 is located between the connector plug 02 and the first elastic member 03, and there is a second gap b between the stopper 04 and the connector plug 02 in the plug-connect direction Z of the connector plug 02. In this solution, the first limiting block 05 bears preload generated by the first elastic member 03 in the preloaded state, so that the connector plug 02 is not in contact with the stopper 04, and at least no press force exists between the connector plug 02 and the stopper 04. Therefore, the elastic force generated by the first elastic member 03 in the preloaded state does not affect the connector plug 02. The connector plug 02 is in a natural state and does not press against a side wall 012 due to the elastic force of the first elastic member 03, so that floating of the connector plug 02 in the first plane (the X direction and the Y direction) is decoupled from floating in the plug-connect direction Z (the Z direction). Flexibility of the connector plug 02 is relatively high, and can enable the connector plug 02 to have relatively good floating effect in the first plane, thereby helping align the connector plug 02 with the counterpart connector 7. In this solution, the first limiting block is disposed, so that the first elastic member 03 has the preload, and the preload does not affect floating of the connector plug 02 in the first plane. In a specific embodiment, the first elastic member 03 can be compressed and provide the preload in the plug-connect direction Z of the connector 5.

In a specific working process, the connector 5 is plug-connected to the counterpart connector 7, and when the connector plug 02 is opposite to the counterpart connector 7, floating can be generated in the first plane, so that the connector plug 02 is well aligned with the counterpart connector 7. Then, the connector plug 02 is plug-connected to the counterpart connector 7 in the plug-connect direction Z. As the plug-connect process is performed, the connector plug 02 can move toward the stopper 04 under effect of the counterpart connector 7. When a moving distance exceeds the second gap b, the connector plug 02 presses against the stopper 04. When plug-connect force between the connector plug 02 and the counterpart connector 7 is greater than the preload of the first elastic member, the connector plug 02 drives the stopper 04 to continue moving toward the bottom wall 011, so that the connector plug 02 floats in the plug-connect direction Z. Under effect of the first elastic member 03, the connector plug 02 may be enabled to closely connect to the counterpart connector 7, to effectively reduce a partial mating distance (demating value), and improve a signal transmission rate of the connector 5, so that the connector 5 can support transmission of a signal with a relatively high rate, for example, transmission of 28G, 56G, or 112G signals.

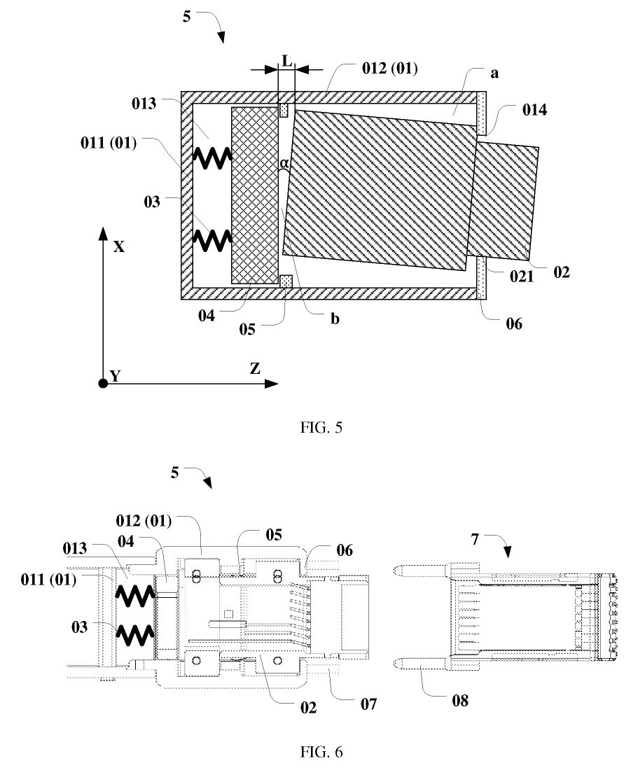

In a specific embodiment, the circuit board assembly 2 may include one connector 5 or a plurality of connectors 5. This is not limited in this disclosure. For example, a size of the circuit board assembly 2 is relatively small, and disposition of one or two connectors 5 is enough for the circuit board assembly 2 to connect to a counterpart circuit board assembly. Alternatively, FIG. 4 is a diagram of a structure of a circuit board assembly according to an embodiment of this disclosure. In the embodiment shown in FIG. 4, the circuit board assembly 2 includes a plurality of connectors 5. In this embodiment, the circuit board assembly 2 has a relatively large size, also includes a relatively large quantity of electronic components 4, and also has a relatively large requirement for performing signal transmission with another circuit board assembly 2. Therefore, a relatively large quantity of connectors 5 are disposed, to implement connection between the circuit board assembly 2 and the counterpart circuit board assembly.

Especially for a large-sized and heavy circuit board assembly 2, relativity large tolerance accumulation exists between the circuit board assembly 2 and a matching structure in a large-sized system, and lateral force and torsional force caused by gravity are also relatively large. The connector 5 has a particular floating capability in the first plane. Therefore, the connector 5 does not easily deform in the X direction and the Y direction of the circuit board assembly 2. In addition, the first elastic member 03 is disposed, so that the circuit board assembly 2 also has a floating capability in the Z direction, and has a relatively strong tolerance absorption capability. In this way, a demating value of matching connectors 5 in the Z direction is relatively small, and coupling impact caused by inconsistent depths of different connectors 5 in the plug-connect direction Z may also be alleviated. In conclusion, the connectors 5 in this disclosure can float in the X direction, the Y direction, and the Z direction, and floating in the X direction and the Y direction is decoupled from floating in the Z direction, so that tightness of connection between the connectors 5 is improved, thereby improving a signal transmission rate.

In addition, the fixed housing 01 of the connector 5 in this solution is of a monolithic sleeve structure, has a relatively simple structure, and can implement floating in three directions: the X direction, the Y direction, and the Z direction. This is particularly applicable to a high-density electronic device.

When the second gap b is specifically formed, the second gap b may be less than or equal to 1 millimeter. In this solution, when the connector 5 is in a natural state, the second gap b enables the connector plug 02 to be not in contact with the stopper 04, and relatively good floating effect is achieved in the first plane. However, in a process in which the connector 5 is plug-connected to the counterpart connector 7, provided that movement in the plug-connect direction Z does not exceed 1 mm, the connector plug 02 can be in contact with and press against the stopper 04. This helps implement floating of the connector 5 in the plug-connect direction Z and improve tightness of the connector 5 and the counterpart connector 7 in the plug-connect direction Z. If the second gap b is excessively large, the first elastic member 03 may not work, and it is difficult to improve effect of connection between the connector 5 and the counterpart connector 7. In a specific embodiment, the second gap b may be 0.2 mm, 0.3 mm, 0.5 mm, 0.6 mm, 0.8 mm, or the like.

Still with reference to FIG. 3, in a possible embodiment, the fixed housing 01 is further fastened to a second limiting block 06. The second limiting block 06 is located on a side that is of the first limiting block 05 and that is away from the stopper 04, and may be specifically located on a side of the opening 014 of the fixed housing 01. When the second limiting block 06 is fastened to the fixed housing 01, the second limiting block 06 may be specifically fastened to the side wall 012 of the fixed housing 01. To match the second limiting block 06, the connector plug 02 includes a shoulder stop 021, the shoulder stop 021 is located between the second limiting block 06 and the stopper 04, and the shoulder stop 021 of the connector plug 02 is in lap joint with the second limiting block 06. When the connector 5 is plug-connected to the counterpart connector 7, the shoulder stop 021 moves in a direction away from the second limiting block 06. In this solution, the connector plug 02 is limited on a side that is of the second limiting block 06 and that faces the bottom wall 011, and does not fall off from the fixed housing 01.

In addition, FIG. 5 is a diagram of a cross-sectional structure of a connector according to an embodiment of this disclosure. FIG. 5 shows a state in which the connector plug 02 rotates in the fixed housing 01. The connector plug 02 is limited between the stopper 04 and the second limiting block 06, and the second gap b between the connector plug 02 and the stopper 04 is relatively small. When the connector plug 02 rotates, a maximum rotation angle between the connector plug 02 and the stopper 04 is α=artan (L/w), where L is a width of the second gap b, and w is a width of a side edge that is of the connector plug 02 and that is adjacent to the stopper 04. Because the width L of the second gap b is relatively small, even if the connector plug 02 rotates, the rotation angle can be controlled within a relatively small range. This helps improve precision of alignment between the connector plug 02 and the counterpart connector 7. Specifically, the rotation angle between the connector plug 02 and the stopper 04 may be understood as an included angle between a surface that is of the connector plug 02 and that faces the stopper 04 and a surface that is of the stopper 04 and that faces the connector plug 02.

In a specific embodiment, the included angle may be less than or equal to 2 degrees. In a further embodiment, a size of the second gap is designed based on a size of the connector 5, so that the included angle is less than or equal to 1 degree. In this solution, the rotation angle of the connector 5 is relatively small. This helps improve alignment precision of the connector 5 and improve connection effect.

When the second limiting block 06 is specifically disposed, the second limiting block 06 and the side wall 012 that is of the fixed housing 01 may be of an integrated structure. This helps improve strength of connection between the second limiting block 06 and the side wall 012. In this case, structures such as the connector plug 02 and the stopper 04 may be mounted on a side that is of the fixed housing 01 and that is away from the second limiting block 06. Alternatively, the second limiting block 06 may be detachably connected to the fixed housing 01, so that the structures such as the connector plug 02 and the stopper 04 may be first mounted in the fixed housing 01, and then the second limiting block 06 is fixedly mounted.

In a specific embodiment, the first elastic member 03 may be a compression spring. Under effect of the first limiting block 05, a distance between the bottom wall 011 and the stopper 04 is less than a length of the compression spring in a free state, and the compression spring is compressed by the bottom wall 011 and the stopper 04, so that the first elastic member 03 is in a compressed state and remains preloaded.

In a connection process, the connector plug 02 drives the stopper 04 to slide toward the bottom wall 011. Therefore, to reduce friction in a sliding process of the stopper 04, a clearance fit may exist between the stopper 04 and the side wall 012 of the fixed housing 01. In this way, the stopper 04 slides relatively smoothly, so that the elastic force of the first elastic member 03 is mainly used as force to drive the connector plug 02 toward the counterpart connector 7, and sliding friction force of the stopper 04 does not need to be overcome. This solution helps reduce a specification requirement of the first elastic member 03.

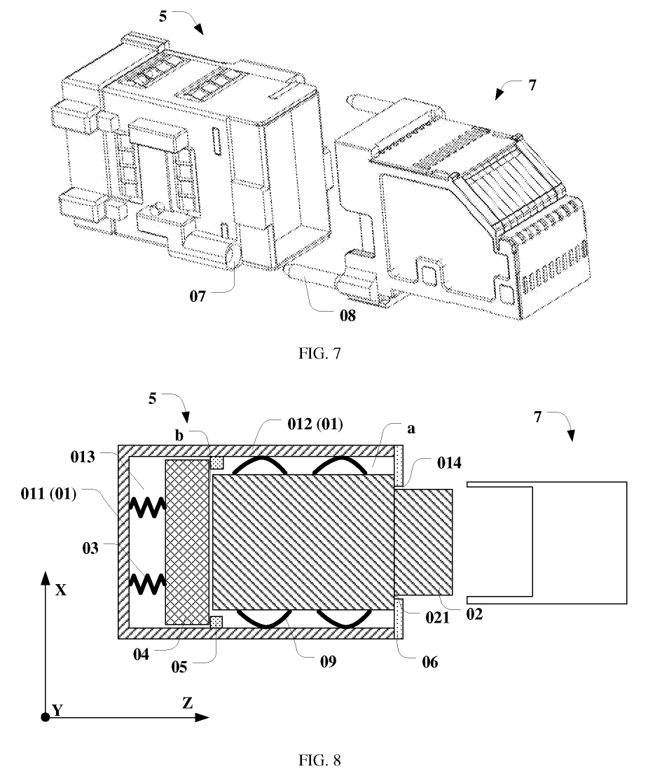

FIG. 6 is a diagram of a structure of a connector and a counterpart connector according to an embodiment of this disclosure. FIG. 7 is a diagram of a structure of another connector and a counterpart connector according to an embodiment of this disclosure. As shown in FIG. 6 and FIG. 7, to reduce difficulty in aligning the connector 5 with the counterpart connector 7, a guide assembly is disposed between the connector 5 and the counterpart connector 7. The guide assembly may include a guide sleeve 07 and a guide pin 08 that match each other. In the plug-connect process, the guide pin 08 is first inserted into the guide sleeve 07 for coarse positioning, and then the connector plug 02 of the connector 5 is aligned with the counterpart connector 7 for plug-connection. The guide assembly in this solution can implement coarse positioning of the connector 5 and the counterpart connector 7, to facilitate alignment between the connector 5 and the counterpart connector 7 for plug-connection. In one aspect, this helps reduce operation difficulty, and in another aspect, this reduces unnecessary collisions between the connectors 5, and helps improve a service life of the connectors 5.

In a specific embodiment shown in FIG. 6 and FIG. 7, the guide sleeve 07 in the guide assembly is fastened to the fixed housing 01 of the connector 5, and the guide pin 08 is fastened to the counterpart connector 7. In the process in which the connector 5 is plug-connected to the counterpart connector 7, the guide pin 08 is gradually inserted into the guide sleeve 07; and when the connector 5 and the counterpart connector 7 are in an engagement state, the guide pin 08 is inserted into the guide sleeve 07.

In another specific embodiment, a difference from the foregoing embodiment lies only in that the guide sleeve 07 and the guide pin 08 are disposed at opposite positions. Specifically, the guide sleeve 07 in the guide assembly may be fastened to the counterpart connector 7, and the guide pin 08 is fastened to the counterpart connector 7. In the process in which the connector 5 is plug-connected to the counterpart connector 7, the guide pin 08 is gradually inserted into the guide sleeve 07; and when the connector 5 and the counterpart connector 7 are in an engagement state, the guide pin 08 is inserted into the guide sleeve 07.

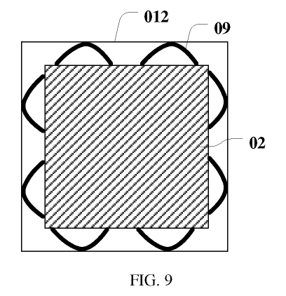

FIG. 8 is a diagram of a structure of another connector and a counterpart connector according to an embodiment of this disclosure. As shown in FIG. 8, in another embodiment of this disclosure, the connector 5 further includes a second elastic member 09. The second elastic member 09 is disposed in the first gap a between the connector plug 02 and the side wall 012, and the second elastic member 09 is configured to drive the connector plug 02 to be reset to an initial position in the first plane. In this solution, when the connector 5 is in a disconnected state, the connector plug 02 may be enabled to keep a state of locating at the preset initial position, for example, the connector plug 02 may be in a middle state. In addition, when the connector 5 and the counterpart connector 7 are in the engagement state, the second elastic member 09 drivers the connector plug 02 to press against the counterpart connector 7 in the first plane, and a demating value of the connector plug 02 and the counterpart connector 7 in the first plane is relatively small, to improve effect of connection between the connector plug 02 and the counterpart connector 7.

In a specific embodiment, the second elastic member 09 may be a reset component such as a spring plate or a spring. One end of the spring plate or the spring is fastened to the fixed housing 01, and the other end is fastened to the connector plug 02. The spring plate has a relatively simple structure, and occupies relatively small space. In addition, a group of second elastic members 09 may be disposed in the first gap a, and each group of second elastic members 09 may include one or more second elastic members 09. This is not limited in this disclosure, provided that the connector plug 02 can be driven to be reset.

Still with reference to FIG. 8, in a specific embodiment, the connector 5 may include two groups of second elastic members 09, and the two groups of second elastic members 09 are disposed on two sides that are away from each other of the connector plug 02. In this solution, the second elastic members 09 may reset the connector plug 02 in different directions, and improve effect of connection between the connector plug 02 and the counterpart connector 7 in different directions.

FIG. 9 is a diagram of a cross-sectional structure of a connector according to an embodiment of this disclosure. As shown in FIG. 9, in a further embodiment, the fixed housing 01 includes four side walls 012. In this case, the connector 5 may further include four groups of second elastic members 09, and the second elastic members 09 are disposed in the first gap a between each side wall 012 and the connector plug 02. In this solution, the second elastic members 09 are disposed on a periphery of the connector plug 02, so that effect of connection between the connector plug 02 and the counterpart connector 7 in different directions can be further improved.

In the accompanying drawings of the foregoing embodiments, an example in which the connector plug 02 is a male connector is used for description. In actual disclosure, the connector plug 02 may be a female connector or a male connector. This is not limited in this disclosure.

The foregoing descriptions are merely specific embodiments of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

What is claimed is:

1. A connector, wherein the connector comprises a fixed housing, a connector plug, a first elastic member, and a stopper, wherein
the fixed housing comprises a bottom wall and side walls, the bottom wall and the side walls are connected to form an insertion cavity, the connector plug is mounted in the insertion cavity, and a first gap exists between the connector plug and the side wall;
the first elastic member is disposed between the bottom wall and the stopper, and the first elastic member is configured to drive the stopper to float in a plug-connect direction of the connector plug; and the stopper is located between the connector plug and the first elastic member, and a second gap exists between the stopper and the connector plug in the plug-connect direction; and
the fixed housing is fastened to a first limiting block, the first limiting block is disposed on a side that is of the stopper and that is away from the first elastic member, and the first elastic member remains preloaded, to drive the stopper to press against the first limiting block.

2. The connector according to claim 1, wherein the connector is configured to plug-connect to a counterpart connector;
the fixed housing is provided with a first guide sleeve, the counterpart connector is provided with a first guide pin, and when the connector and the counterpart connector are in an engagement state, the first guide pin is inserted into the first guide sleeve; or
the fixed housing is provided with a second guide pin, the counterpart connector is provided with a second guide sleeve, and when the connector and the counterpart connector are in an engagement state, the second guide pin is inserted into the second guide sleeve.

3. The connector according to claim 1, further comprising a second elastic member, wherein the second elastic member is disposed in the first gap between the connector plug and the side wall, the second elastic member is configured to drive the connector plug to float in a first plane and press against the counterpart connector, and the first plane is perpendicular to the plug-connect direction of the connector plug.

4. The connector according to claim 3, comprising two groups of second elastic members, wherein the two groups of second elastic members are disposed on two sides that are away from each other of the connector plug.

5. The connector according to claim 1, wherein a width of the second gap is less than or equal to 1 millimeter.

6. The connector according to claim 1, wherein the fixed housing is fastened to a second limiting block, the connector plug comprises a shoulder stop, the shoulder stop is located between the second limiting block and the stopper, and the shoulder stop is in lap joint with the second limiting block.

7. The connector according to claim 6, wherein an included angle between a surface that is of the connector plug and that faces the stopper and a surface that is of the stopper and that faces the connector plug is less than or equal to 2 degrees.

8. The connector according to claim 1, wherein a clearance fit exists between the stopper and the side wall.

9. The connector according to claim 1, wherein a lubricant is disposed between the stopper and the side wall.

10. The connector according to claim 1, wherein the connector plug is a female connector or a male connector.

11. A circuit board assembly, comprising a circuit board, an electronic component, and a connector, wherein the electronic component is disposed on the circuit board, and the electronic component is electrically connected to the connector plug of the connector, wherein the connector comprises a fixed housing, a connector plug, a first elastic member, and a stopper, wherein
the fixed housing comprises a bottom wall and side walls, the bottom wall and the side walls are connected to form an insertion cavity, the connector plug is mounted in the insertion cavity, and a first gap exists between the connector plug and the side wall;
the first elastic member is disposed between the bottom wall and the stopper, and the first elastic member is configured to drive the stopper to float in a plug-connect direction of the connector plug; and the stopper is located between the connector plug and the first elastic member, and a second gap exists between the stopper and the connector plug in the plug-connect direction; and
the fixed housing is fastened to a first limiting block, the first limiting block is disposed on a side that is of the stopper and that is away from the first elastic member, and the first elastic member remains preloaded, to drive the stopper to press against the first limiting block.

12.The circuit board assembly according to claim 11, wherein the connector is configured to plug-connect to a counterpart connector;
the fixed housing is provided with a first guide sleeve, the counterpart connector is provided with a first guide pin, and when the connector and the counterpart connector are in an engagement state, the first guide pin is inserted into the first guide sleeve; or
the fixed housing is provided with a second guide pin, the counterpart connector is provided with a second guide sleeve, and when the connector and the counterpart connector are in an engagement state, the second guide pin is inserted into the second guide sleeve.

13. The circuit board assembly according to claim 11, further comprising a second elastic member, wherein the second elastic member is disposed in the first gap between the connector plug and the side wall, the second elastic member is configured to drive the connector plug to float in a first plane and press against the counterpart connector, and the first plane is perpendicular to the plug-connect direction of the connector plug.

14. The circuit board assembly according to claim 13, comprising two groups of second elastic members, wherein the two groups of second elastic members are disposed on two sides that are away from each other of the connector plug.

15. The circuit board assembly according to claim 11, wherein a width of the second gap is less than or equal to 1 millimeter.

16. The circuit board assembly according to claim 11, wherein the fixed housing is fastened to a second limiting block, the connector plug comprises a shoulder stop, the shoulder stop is located between the second limiting block and the stopper, and the shoulder stop is in lap joint with the second limiting block.

17. The circuit board assembly according to claim 16, wherein an included angle between a surface that is of the connector plug and that faces the stopper and a surface that is of the stopper and that faces the connector plug is less than or equal to 2 degrees.

18. The circuit board assembly according to claim 11, further comprising an electrical connection line, wherein the electrical connection line is connected between the electronic component and the connector plug.

19. An electronic device, comprising a housing and a circuit board assembly, wherein the circuit board assembly is disposed in the housing, wherein the circuit board assembly comprising a circuit board, an electronic component, and a connector, wherein the electronic component is disposed on the circuit board, and the electronic component is electrically connected to the connector plug of the connector, wherein the connector comprises a fixed housing, a connector plug, a first elastic member, and a stopper, wherein
the fixed housing comprises a bottom wall and side walls, the bottom wall and the side walls are connected to form an insertion cavity, the connector plug is mounted in the insertion cavity, and a first gap exists between the connector plug and the side wall;
the first elastic member is disposed between the bottom wall and the stopper, and the first elastic member is configured to drive the stopper to float in a plug-connect direction of the connector plug; and the stopper is located between the connector plug and the first elastic member, and a second gap exists between the stopper and the connector plug in the plug-connect direction; and
the fixed housing is fastened to a first limiting block, the first limiting block is disposed on a side that is of the stopper and that is away from the first elastic member, and the first elastic member remains preloaded, to drive the stopper to press against the first limiting block.

20. The electronic device according to claim 19, wherein the fixed housing and the circuit board are fixedly mounted in the housing separately; and the circuit board assembly further comprises the electrical connection line, and the electrical connection line is connected between the electronic component and the connector plug.
